(19) United States
(12) Patent Application Publication
(10) Pub. No.: US 2013/0336611 A1
(43) Pub. Date: Dec. 19, 2013

(54) OPTICAL DEVICE

(71) Applicant: Gwangju Institute of Science and Technology, Gwangju (KR)

(72) Inventors: YONG-TAK LEE, Gwangju (KR); Sooraj Ravindran, Gwangju (KR); Chan IL Yeo, Gwangju (KR)

(21) Appl. No.: 13/919,515

(22) Filed: Jun. 17, 2013

(30) Foreign Application Priority Data
Jun. 18, 2012 (KR) 10-2012-0064886

(51) Int. Cl. G02F 1/025

(52) U.S. Cl. CPC G02F 1/025
USPC 385/2

(57) ABSTRACT

An optical device includes a first waveguide extended in one direction. A second waveguide is positioned at a side of the first waveguide. The second waveguide includes the first conductive semiconductor layer, the second conductive semiconductor layer, and the undoped semiconductor layer positioned between the first conductive semiconductor layer and the second conductive semiconductor layer, wherein the undoped semiconductor layer has a refractive index larger than those of the first conductive semiconductor layer and the second conductive semiconductor layer. First and second electrodes are connected to the first conductive semiconductor layer and the second conductive semiconductor layer of the second waveguide, respectively.

### CROSS REFERENCE TO RELATED APPLICATION

This application claims the benefit of Korean Patent Application No. 10-2012-0064886, filed on 18 Jun. 2012, which is hereby incorporated by reference in its entirety into this application.

### BACKGROUND OF THE INVENTION

1. Technical Field

The present invention relates to a semiconductor device, and more particularly, to a semiconductor based optical device.

2. Description of the Related Art

An optical switch and an optical modulator operated at a wavelength of 1.3 μm and 1.55 μm mainly used for optical communication mainly made of a lithium niobate (LiNbO₃) material and use an electro-optic (EO) effect as a principal mechanism of operation. However, these optical devices have a large volume and are very sensitive to polarization characteristics of light, such that they are not appropriate for being utilized in an optical communication system. In addition, these optical devices are made of LiNbO₃ rather than a semiconductor material, such that it is difficult to integrate these optical devices together with other semiconductor devices and platforms.

An optical switch and an optical modulator made of the semiconductor material may be integrated together with semiconductor devices such as a laser diode, an optical amplifier, a photo-detector, such that utilization thereof is very high. However, an effect of operating a semiconductor material based device using the electro-optic effect is less than an effect of operating a LiNbO₃ based device using the electro-optic effect.

Generally, a semiconductor based optical switch and optical modulator used for optical communication use an electro absorption (EA) effect as a principal mechanism of operation. The electro absorption effect indicates an effect of changing (tilting) an energy level of a semiconductor material through the supply of a bias to allow bandgap energy of the semiconductor material and photon energy of an optical signal to be matched to each other, such that an absorption rate of an optical signal (photon) by the semiconductor material is changed to change a refractive index of the semiconductor material. In order to efficiently switch and modulate the optical signal using the electro absorption effect, a semiconductor material having bandgap energy close to the photon energy of the optical signal is required. The reason is that an intensity of the electro absorption effect is the strongest when the photon energy of the optical signal is in the vicinity of the bandgap energy of the semiconductor material and becomes weaker as the photon energy of the optical signal becomes smaller than the bandgap energy of the semiconductor material. However, in the case in which the photon energy of the optical signal becomes close to or is higher than the bandgap energy of the semiconductor material, absorption of the optical signal by the semiconductor material is increased, such that loss of the optical signal is also increased, thereby decreasing performance of the electro absorption effect based optical device.

A wavelength at which the electro absorption effect based optical switch and optical modulator may be operated is limited depending on a composition ratio of the semiconductor material, and a single apparatus may not use several wavelengths. In other words, an optical switch or an optical modulator made of a semiconductor material having a material composition ratio appropriate for an operating wavelength may smoothly perform a switching or modulating role only at a single wavelength. This makes design of the electro absorption effect based optical switch and modulator complicated.

Among methods used in order to enhance the electro absorption effect, there is a method of allowing a quantum well structure to be inclined in a semiconductor structure. However, the quantum well structure has disadvantages in that growth is complicated, close attention should be paid at the time of growth, and a width of the quantum well needs to be accurately adjusted, thereby making design and manufacture of the electro absorption effect based optical switch and modulator difficult. In addition, in the case in which the semiconductor structure includes the quantum well structure, it shows polarization dependent characteristics. As a result, performance of the electro absorption effect based optical switch and modulator depends on polarization of an input optical signal. In order to solve these polarization dependent characteristics, additional components such as a polarizer are required, which makes the entire configuration of a system complicated in an optical communication application.

### SUMMARY OF THE INVENTION

An object of the present invention is to provide an optical device that is capable of being integrated together with other semiconductor devices by being compatible with a semiconductor process, has polarization independent characteristics, does not cause loss of an optical signal due to light absorption, and is capable of performing various functions in a small area without a quantum well structure.

According to an aspect of the present invention, there is an optical device. The optical device includes a first waveguide extended in one direction. A second waveguide is positioned at a side of the first waveguide. The second waveguide includes a first conductive semiconductor layer, a second conductive semiconductor layer, and an undoped semiconductor layer positioned between the first conductive semiconductor layer and the second conductive semiconductor layer, wherein the undoped semiconductor layer has a refractive index larger than those of the first conductive semiconductor layer and the second conductive semiconductor layer. First and second electrodes are connected to the first conductive semiconductor layer and the second conductive semiconductor layer of the second waveguide, respectively.

According to another aspect of the present invention, there is an optical device. The optical device includes a first waveguide extended in one direction. A second waveguide is positioned at a side of the first waveguide. The second waveguide includes a first cladding layer, a second cladding layer, and a core layer positioned between the first and second cladding layer, wherein the core layer has an effective refractive index changed depending on a bias voltage applied to the first and second cladding layers.

### BRIEF DESCRIPTION OF THE DRAWINGS

FIG. 1 is a graph showing a change in an effective refractive index according to a wavelength when a forward bias is applied to a GaAs layer;

FIG. 2A is a plan view of an optical device according to a first exemplary embodiment of the present invention, and FIG. 2B is a cross-sectional view taken along the cut line I-I′ of FIG. 2A;

FIG. 3A is a plan view of an optical device according to a second exemplary embodiment of the present invention, and FIG. 3B is a cross-sectional view taken along the cut line I-I′ of FIG. 3A;

FIG. 4A is a plan view of an optical device according to a third exemplary embodiment of the present invention, and FIG. 4B is a cross-sectional view taken along the cut line I-I′ and the cut line II-II′ of FIG. 4A;

FIG. 5 is a perspective view showing an optical device according to a fourth exemplary embodiment of the present invention;

FIGS. 6A and 6B are cross-sectional views taken along the cut line II-II′ of FIG. 1 for each process step and showing a method of manufacturing an optical device according to the exemplary embodiment of the present invention;

FIGS. 7 and 8 are perspective views showing a method of operating an optical device shown in FIG. 1;

FIG. 9 is a graph showing that the optical device described with reference to FIGS. 5 to 8 is operated as an optical switch or an optical modulator;

FIG. 10 is a graph showing that the optical device described with reference to FIGS. 5 to 8 is operated as an optical splitter;

FIG. 11 is a graph showing that the optical device described with reference to FIGS. 5 to 8 is operated as an optical attenuator;

FIG. 12A is a plan view of an optical device according to a fifth exemplary embodiment of the present invention, and FIG. 12B is a cross-sectional view taken along the cut line I-I′ of FIG. 12A;

FIG. 13 is a perspective view showing an optical device according to another exemplary embodiment of the present invention;

FIG. 14A is a graph showing a change in a refractive index for a bias voltage applied to each resonant ring of an optical device according to Preparation Example 1, and FIG. 14B is a graph showing a change in a refractive index for a carrier density generated when the bias voltage is applied to each resonant ring of the optical device according to Preparation Example 1;

FIGS. 15A and 15B are graphs showing normalized intensities of wavelengths output from a transmission waveguide and a dropping waveguide for a series of wavelengths input to a transmission waveguide of the optical device according to Preparation Example 1, respectively; and

FIG. 16 is a graph showing normalized intensities of 1305.28 nm and 1560.16 nm, which are output wavelengths for a change amount in a refractive index when a bias is applied to the resonant rings of the optical device according to Preparation Example 1.

### DESCRIPTION OF THE EXEMPLARY EMBODIMENTS

Hereinafter, exemplary embodiments of the present invention will be described in more detail with reference to the accompanying drawings in order to describe the present invention in more detail. Therefore, the present invention is not limited to the exemplary embodiments set forth herein, but may be modified in many different forms.

In the present specification, in the case in which it is stated that a layer is present ‘on’ another layer or a substrate, the layer may be directly formed on another layer or the substrate or have the other layer interposed therebetween. Further, in the present specification, directional representations such as ‘upward’, ‘upper portion’, ‘upper surface’, and the like, may also be understood as meanings of ‘downward’, ‘lower portion’, ‘lower surface’, or ‘sideward’, ‘side portion’, ‘side surface’, and the like. That is, a representation of a spatial direction should be understood as a relative direction and should not be understood as a restrictive meaning such as an absolute direction. Further, in the present specification, terms such as ‘first’ or ‘second’ should be understood as terms that do not restrict any components, but are used in order to distinguish components from each other.

In addition, like reference numerals denote like elements throughout the specification.

In an optical device including a first conductive semiconductor layer, a second conductive semiconductor layer, and an undoped semiconductor layer (or an intrinsic semiconductor layer) interposed between the first conductive semiconductor layer and the second conductive semiconductor layer, when a bias voltage is applied between the first conductive semiconductor layer and the second conductive semiconductor layer, a density of free carriers in the undoped semiconductor layer may be changed. The change in the density of the free carriers as described above may change an effective refractive index of the undoped semiconductor layer.

The change in the effective refractive index by the change in the density of the free carriers may be caused by a bandgap shrinkage (BGS) effect, a band filling (BF) effect, and a free carrier absorption (FCA) effect.

First, a principle of the bandgap shrinkage will be described. In the case in which a forward bias is applied to the optical device, electrons are accumulated at a lower portion of a conduction band of the undoped semiconductor layer and holes are accumulated at an upper portion of a valence band of the undoped semiconductor layer. Wave functions of the electrons and the holes are not overlapped with each other in the case in which a concentration of carriers (electrons and holes) is low. However, in the case in which a carrier density exceeds critical carrier density, wave functions of injected carriers interact with each other. The interaction of the carriers as described above moves (lowers) a conduction band edge of the undoped semiconductor layer downward and moves (raises) a valence band edge upward. Therefore, a bandgap of the undoped semiconductor layer is shrunk, which is called the bandgap shrinkage.

In addition, when the forward bias is applied to the optical device, the carriers are injected into the undoped semiconductor layer, such that the conduction band of the undoped semiconductor layer may be filled with electrons. As a result, an energy state that the electrons may occupy in the conduction band rises. The rise in the energy level at which the electrons may be positioned means that energy of photons that may be absorbed by the undoped semiconductor layer also rises. As a result, an absorption rate by the undoped semiconductor layer is decreased, which is called the band filling effect.

The following Equation shows a change in an absorption coefficient by the bandgap shrinkage effect and the band filling effect.

$${Δα}_{BGS + BF} = \frac{{C}_{bh}}{E} ( {f}_{g} ( {E}_{qh} ) - {f}_{c} ( {E}_{ch} ) ) \frac{{C}_{lh}}{E} ( {f}_{o} ( {E}_{ol} ) - {f}_{c} ( {E}_{d} ) ) \times \sqrt{E - {E}_{g}^{r}} - [ \frac{{C}_{hh}}{E} \sqrt{E - {E}_{g}} + \frac{{C}_{lh}}{E} \sqrt{E - {E}_{g}} ] \qquad [ Equation 1 ]$$

Where Cₕₕ and Cₗₕ indicate constants, respectively, and fᵥ and f_{c} indicates Fermi probability functions, respectively. E′_{g} means bandgap energy decreased by the bandgap shrinkage effect, and E_{g} and E indicate the bandgap energy and energy of a photon, respectively.

The following Equation shows a change in an effective refractive index of the undoped semiconductor layer due to a change in an absorption rate by the bandgap shrinkage effect and the band filling effect.

$$Δ {n}_{BGS + BF} = \frac{C \overline{h}}{π} PV ( {\int }_{0}^{to} \frac{Δα {E}_{BGS + BP}}{{E}^{Q} - {E}_{a}^{2}} d \overline{E} ) \qquad [ Equation 2 ]$$

Where Δn_{BGS+BF} and Δα_{BGS+BF} indicate a change in an effective refractive index and a change in an absorption coefficient by the bandgap shrinkage effect and the band filling effect, respectively, and PV indicates a principal value of the integral.

Meanwhile, the photons may be absorbed by free carriers (electrons or holes) present in the conduction band or the valence band of the undoped semiconductor layer. It is called a free carrier absorption effect and changes the effective refractive index as follows.

$$Δ {n}_{PGi} = - \frac{6.9 \times {10}^{- 22}}{{nE}^{2}} [ \frac{N}{{m}_{e}} + P ( \frac{{m}_{hh}^{1 \text{/} 2} + {m}_{lh}^{1 \text{/} 2}}{{m}_{hh}^{3 \text{/} 2} + {m}_{lh}^{3 \text{/} 2}} ) ] \qquad [ Equation 3 ]$$

Where Δn_{FCA} means a change in an effective refractive index of a semiconductor material by free carrier absorption, N and P indicate the numbers of electrons and holes, respective, and mₑ, mₕₕ, and mₗₕ indicate effective masses of electrons, heavy holes, and light holes, respectively.

A total change amount (Δn_{ToTAL}) in the effective refractive index by the bandgap shrinkage effect, the band filling effect, and the free carrier absorption effect is as follows.

Δn_{Total}=Δn_{BGS+BF}+Δn_{PCA} [Equation 4]

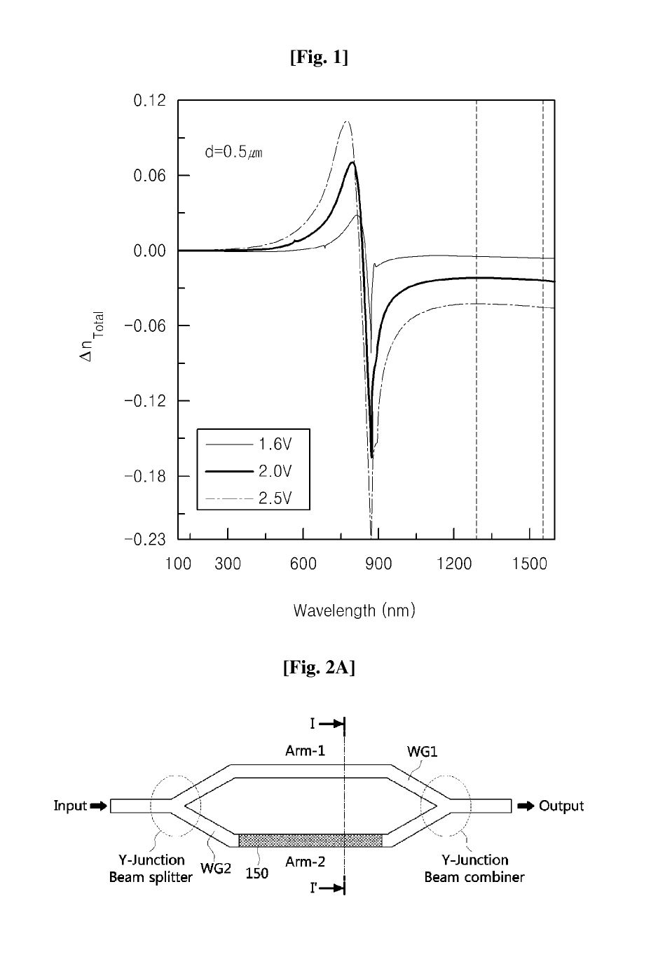

FIG. 1 is a graph showing a change in an effective refractive index according to a wavelength when a forward bias is applied to a GaAs layer.

Referring to FIG. 1, when carriers are injected into a GaAs layer by applying forward biases (1.6V, 2.0V, and 2.5V) to the GaAs layer, an effective refractive index of the GaAs layer is decreased (a change amount is a negative number) in a wavelength (>870 nm) having photon energy smaller than bandgap energy (870 nm, 1.424 eV) of GaAs. In an operation wavelength further away than a wavelength corresponding to a bandgap of GaAs, a change in a refractive index by carrier injection becomes very large in the degree that switching or modulation in a region i is impossible. Black dotted lines in FIG. 1 indicate wavelengths of 1.3 μm and 1.5 μm mainly used in optical communication.

The above-mentioned principle may be applied to optical devices including a Mach-Zehnder interferometer (MZI), a directional coupler (DC), a ring resonator, or a combination thereof using a structure including a first conductive semiconductor layer, a second conductive semiconductor layer, and an undoped semiconductor layer (or an intrinsic semiconductor layer) interposed between the first conductive semiconductor layer and the second conductive semiconductor layer, as described below.

### First Exemplary Embodiment

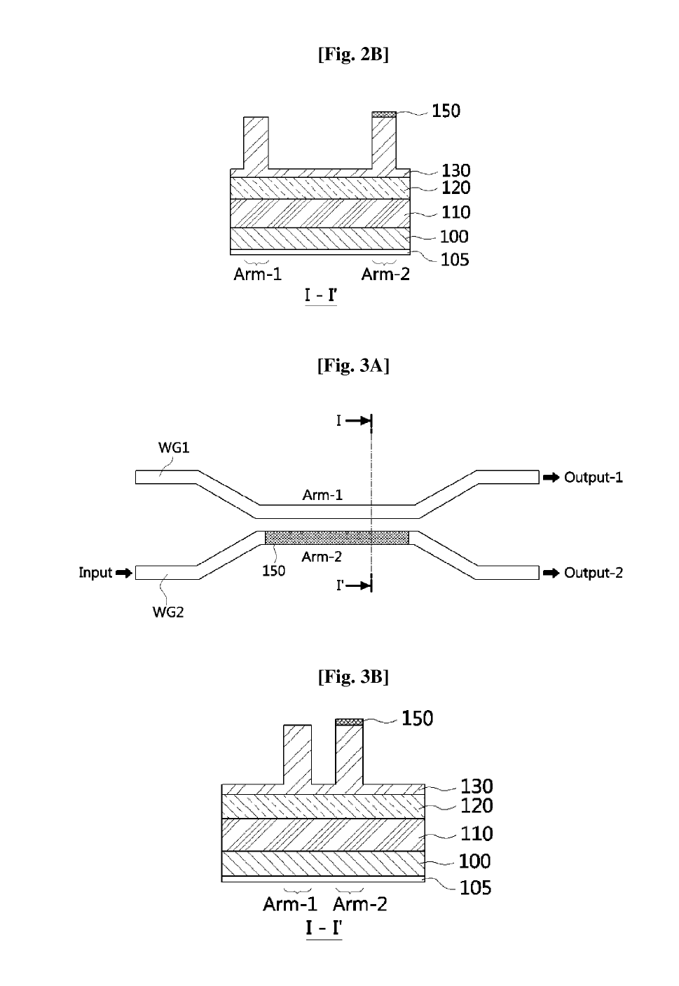

FIG. 2A is a plan view of an optical device according to a first exemplary embodiment of the present invention, and FIG. 2B is a cross-sectional view taken along the cut line I-I′ of FIG. 2A. The optical device according to the present embodiment may be a Mach-Zehnder interferometer.

Referring to FIGS. 2A and 2B, a substrate 100 is provided. The substrate 100 may be a conductor substrate or a semiconductor substrate. The conductor substrate may be a metal substrate, and the semiconductor substrate may be a GaAs substrate, a GaN substrate, an InP substrate, or a GaP substrate.

A first electrode 105 may be disposed beneath the substrate 100. Meanwhile, a first cladding layer 110, a core layer 120, and a second cladding layer 130 are sequentially disposed on the substrate 100. The first cladding layer 110, the core layer 120, and the second cladding layer 130 may configure a double hetero junction diode. Specifically, the first cladding layer 110 may be a first conductive semiconductor layer, the second cladding layer 130 may be a second conductive semiconductor layer, and the core layer 120 may be an undoped semiconductor layer. In addition, the first cladding layer 110 may be an n-type semiconductor layer, and the second cladding layer 130 may be a p-type semiconductor layer. The core layer 120 may have a thickness of about 0.1 μm to 1 μm.

In the case in which the core layer 120 is the undoped semiconductor layer, an optical signal propagated through the core layer 120 may have a wavelength corresponding to energy smaller than bandgap energy of the core layer 120. In this case, since the optical signal may not be absorbed by the core layer 120, loss of the optical signal propagated through the core layer 120 may be decreased. The optical signal may have a wavelength of 700 nm or more. Specifically, the optical signal may have a wavelength of 1000 nm or more. More specifically, the optical signal may have a wavelength of 1300 nm to 1600 nm. As the most specific example, the optical signal may have a wavelength of about 1300 nm or about 1550 nm mainly used in a wired optical communication field. However, the present invention is not limited thereto.

The core layer 120 and the cladding layers 110 and 130 may be semiconductor layers made of a compound such as GaAs/AlGaAs, AlₓGa₁₋ₓAs/Al_{y}Ga_{1-y}As (y>x, 0<x<1, and 0<y<1, preferably y>x+0.2 and 0<x<0.45), InGaAs/InAlAs, InGaAsP/InP, In_{y}Ga_{1-y}As₁₋ₓPₓ/InGa_{1-b}As₁₋ₐPₐ (a>x, 0<x<1, 0<y<1, 0<a<1, and 0<b<1, preferably a>x+0.2 and 0.1<x<1), GaN/InGaN, AlInN/GaN, and the like, or a combination thereof. Specifically, the core layer 120 and the cladding layers 110 and 130 may be made of GaAs/AlGaAs in which In that is comparatively expensive and P that has toxicity, inflammability, and explosiveness are not used. In addition, the core layer 120 and the cladding layers 110 and 130 may be epitaxially grown on the substrate 100 by metal organic chemical vapor deposition (MOCVD), molecular beam epitaxy (MBE), or the like.

The second cladding layer 130 has regions having different thicknesses. Since the possibility that a thick region of the second cladding layer 130 will confine light thereunder is higher as compared with other regions of the second cladding layer 130, the thick region of the second cladding layer 130 may be defined as a waveguide. Specifically, the thick region of the second cladding layer 130 may define a first waveguide WG1 and a second waveguide WG2. One end of the first waveguide WG1 and one end of the second waveguide WG2 may be coupled to each other, and the other end of the first waveguide WG1 and the other end of the second waveguide WG2 may also be coupled to each other. As a result, the optical device may include an input port, a Y-junction beam splitter, an arm-1 Arm-1, an arm-2 Arm-2, a Y-junction beam combiner, and an output port. Here, an interval between the first and second waveguides WG1 and WG2 except for regions at which one ends of the first and second waveguides WG1 and WG2 are coupled to each other and the other ends of the first and second waveguides WG1 and WG2 are coupled to each other, that is, an interval between the arm-1 Arm-1 and the arm-2 Arm-2 may be too large to generate coupling therebetween.

A second electrode 150 may be disposed on the second cladding layer 130 of the arm-2 Arm-2. The core layer 120 may have a refractive index larger than those of the first and second cladding layers 110 and 130. Therefore, the light may be confined in the core layer 120 due to a difference in the refractive index. In summary, the light may be confined in the core layer 120 under the thick region of the second cladding layer 130.

An effective refractive index (n_{eff}) of the core layer 120 may depend on a density of free carriers in the core layer 120. As described above, when the density of the free carriers in the core layer 120 is increased, the effective refractive index of the core layer 120 may be decreased. On the contrary, when the density of the free carriers in the core layer 120 is decreased, the effective refractive index of the core layer 120 may be increased. The density of the free carriers in the core layer 120 may depend on a bias voltage applied across the core layer 120. As an example, when a forward bias is applied between the first and second electrodes 105 and 150, electrons and holes are injected into the core layer 120 in the arm-2 Arm-2 region, such that the density of the free carriers may be increased. On the contrary, when a reverse bias is applied between the first and second electrodes 105 and 150, a depletion region in the core layer 120 in the arm-2 Arm-2 region is increased, such that the density of the free carriers may be decreased. A change in the effective refractive index (n_{eff}) of the core layer 120 may change a phase of light moved in the core layer 120.

An operation principle of the optical device will be described below.

Optical signals input at the input port are bisected by the Y-junction beam splitter, are propagated to the arm-1 and the arm-2, are again combined with each other by the Y-junction beam combiner, and are then output to the output port. Here, in the case in which a bias, for example, a forward bias is applied between the first and second electrodes 105 and 150, carriers are injected into the core layer 120 in the arm-2 region, such that the effective refractive index may be changed. As described above, the change of the effective refractive index may change the phase of the light moved in the core layer 120 in the arm-2 region. Therefore, the light moved in the arm-1 region and the light moved in the arm-2 region may have different phases. The optical signal output to the output port may be switched or modified according to the phase difference as described above. As an example, in the case in which the bias is sufficient to change the phase of the light moved in the core layer 120 in the arm-2 region by π (180°), the light moved in the arm-1 region and the light moved in the arm-2 region are offset against and interfere with each other, such that the optical signal may not be detected at the output port.

### Second Exemplary Embodiment

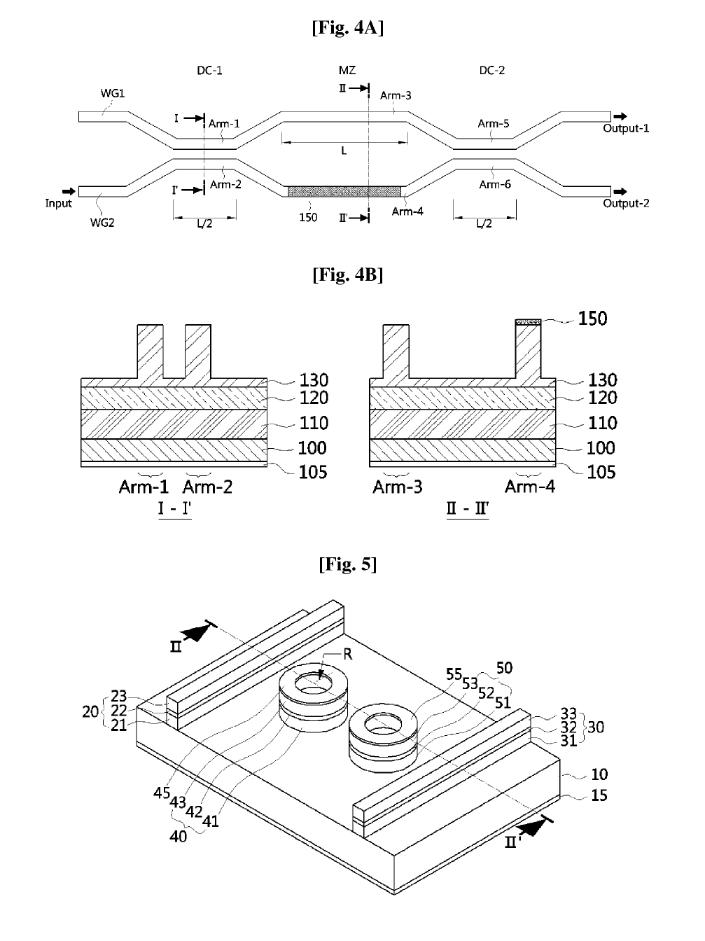

FIG. 3A is a plan view of an optical device according to a second exemplary embodiment of the present invention, and FIG. 3B is a cross-sectional view taken along the cut line I-I′ of FIG. 3A. The optical device according to the present embodiment may be a directional coupler. The optical device according to the present invention has a cross-sectional structure similar to that of the optical device according to the first exemplary embodiment of the present invention except for a structure to be described below.

Referring to FIGS. 3A and 3B, a substrate 100 is provided. A first electrode 105 may be disposed beneath the substrate 100. Meanwhile, a first cladding layer 110, a core layer 120, and a second cladding layer 130 are sequentially disposed on the substrate 100. The second cladding layer 130 has regions having different thicknesses. Since the possibility that a thick region of the second cladding layer 130 will confine light thereunder is higher as compared with other regions of the second cladding layer 130, the thick region of the second cladding layer 130 may be defined as a waveguide. Specifically, the thick region of the second cladding layer 130 may define a first waveguide WG1 and a second waveguide WG2. In a region in which an interval between the first and second waveguides WG1 and WG2 becomes narrow enough to generate coupling therebetween due to an interaction of optical fields therebetween, the first and second waveguides WG1 and WG2 may be called an arm-1 and an arm-2, respectively. A second electrode 150 may be disposed on the second cladding layer 130 of the arm-2 Arm-2.

The core layer 120 may have a refractive index larger than those of the first and second cladding layers 110 and 130. Therefore, the light may be confined in the core layer 120 due to a difference in the refractive index. In summary, the light may be confined in the core layer 120 under the thick region of the second cladding layer 130.

An operation principle of the optical device will be described below.

In the case in which a bias voltage is not applied between the first and second electrodes 105 and 150, the core layer 120 in the arm-1 region and the core layer 120 in the arm-2 region may have the same refractive index as each other. Therefore, when optical signals input at an input port of the second waveguide WG2 are moved in the arm-1, most of the optical signals may be coupled to the arm-2. As a result, the optical signal may be detected at an output port output-1 of the first waveguide WG1.

In the case in which a bias, for example, a forward bias is applied between the first and second electrodes 105 and 150, the core layer 120 in the arm-2 region may have a refractive index different from that of the core layer 120 in the arm-1 region. Therefore, when the optical signals input at the input port of the second waveguide WG2 are moved in the arm-1, the optical signals may not be coupled to the arm-2. As a result, the optical signal may be detected at an output port output-2 of the second waveguide WG2.

### Third Exemplary Embodiment

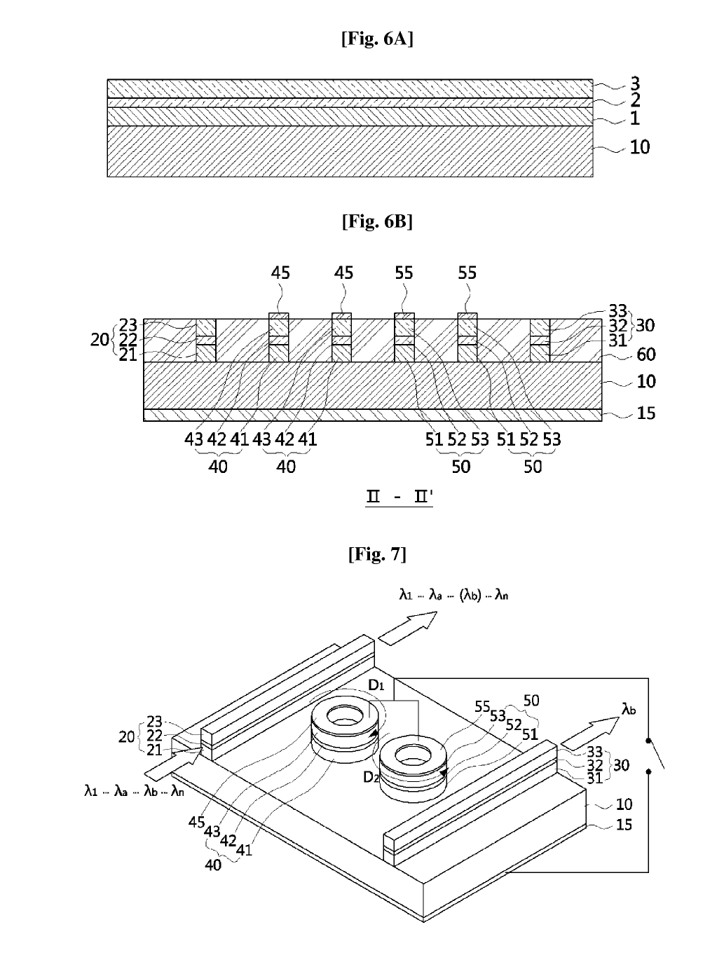

FIG. 4A is a plan view of an optical device according to a third exemplary embodiment of the present invention, and FIG. 4B is a cross-sectional view taken along the cut line I-I′ and the cut line II-II′ of FIG. 4A. The optical device according to the present embodiment may be an optical device in which a Mach-Zehnder interferometer and a directional coupler are combined with each other. The optical device according to the present invention has a cross-sectional structure similar to that of the optical device according to the first exemplary embodiment of the present invention except for a structure to be described below.

Referring to FIGS. 4A and 4B, a substrate 100 is provided. A first electrode 105 may be disposed beneath the substrate 100. Meanwhile, a first cladding layer 110, a core layer 120, and a second cladding layer 130 are sequentially disposed on the substrate 100. The second cladding layer 130 has regions having different thicknesses.

Since the possibility that a thick region of the second cladding layer 130 will confine light thereunder is higher as compared with other regions of the second cladding layer 130, the thick region of the second cladding layer 130 may be defined as a waveguide. Specifically, the thick region of the second cladding layer 130 may define a first waveguide WG1 and a second waveguide WG2. The first and second waveguides WG1 and WG2 may be disposed so that an interval therebetween becomes narrow, becomes wide, and again becomes narrow. Regions in which the interval between the first and second waveguides WG1 and WG2 becomes narrow may be called directional coupling regions DC-1 and DC-2, and a region in which the interval between the first and second waveguides WG1 and WG2 becomes wide may be called a Mach-Zehnder interference region MZ. Therefore, the first directional coupling region DC-1, the Mach-Zehnder interference region MZ, and the second directional coupling region DC-2 may be sequentially disposed in a progress direction of the waveguides. In the directional coupling regions DC-1 and DC-2, the interval between the first and second waveguides WG1 and WG2 may become narrow enough to generate coupling therebetween due to an interaction of optical fields therebetween, and in the Mach-Zehnder interference region MZ, the interval between the first and second waveguides WG1 and WG2 may be too large to generate the coupling therebetween. When it is assumed that a length of the Mach-Zehnder interference region MZ is L, lengths of the directional coupling regions DC-1 and DC-2 may be L/2.

The first and second waveguides WG1 and WG2 may be called an Arm-1 and an Arm-2, respectively, in the first directional coupling region DC-1, be called an Arm-3 and an Arm-4, respectively, in the Mach-Zehnder interference region MZ, and be called an Arm-5 and an Arm-6, respectively, in the second directional coupling region DC-2. A second electrode 150 may be disposed on the second cladding layer 130 of the Arm-4.

The core layer 120 may have a refractive index larger than those of the first and second cladding layers 110 and 130. Therefore, the light may be confined in the core layer 120 due to a difference in the refractive index. In summary, the light may be confined in the core layer 120 under the thick region of the second cladding layer 130.

An operation principle of the optical device will be described below.

First, an optical signal having a phase of 0 and an intensity of 1 may be input to an input port of the second waveguide WG2. This optical signal may be coupled from the arm-2 of the first directional coupling region DC-1 to the arm-1 thereof to thereby be split into a first optical signal having a phase of π/2 and an intensity of ½ in the arm-1 and a second optical signal having a phase of 0 and an intensity of ½ in the arm-2. Then, the first optical signal may pass through the Mach-Zehnder interference region MZ through the arm-3, and the second optical signal may pass through the Mach-Zehnder interference region MZ through the arm-4. Here, in the case in which a bias is not applied between the first and second electrodes 105 and 150, the first optical signal may be maintained in a state in which it has the phase of π/2 and the intensity of ½. In addition, the second optical signal may also be maintained in a state in which it has the phase of 0 and the intensity of ½. Then, in the second directional coupling region DC-2, the first optical signal (having the phase of π/2 and the intensity of ½) is coupled from the arm-5 to the arm-6, such that a signal having a phase of π obtained by adding π/2 to the phase of the first optical signal and an intensity of ¼ may be transferred in the arm-6 and a signal having a phase of π/2 and an intensity of ¼ may remain in the arm-5. Meanwhile, the second optical signal (having the phase of 0 and the intensity of ½) is coupled from the arm-6 to the arm-5, such that a signal having a phase of π/2 obtained by adding π/2 to the phase of the second optical signal and an intensity of ¼ may be transferred in the arm-5 and a signal having a phase of 0 and an intensity of ¼ may remain in the arm-6. As a result, at an output port output-1 of the first waveguide WG1 connected to the arm-5, the optical signal having the phase of π/2 and the intensity of ¼, which remains in the arm-5, and the optical signal having the phase of π/2 and the intensity of ¼, which is transferred from the arm-6, constructively interfere with each other, such that an optical signal having a phase of π/2 and an intensity of ½ may be detected. Meanwhile, at an output port output-2 of the second waveguide WG2 connected to the arm-6, the optical signal having the phase of 0 and the intensity of ¼, which remains in the arm-6, and the optical signal having the phase of π and the intensity of ¼, which is transferred from the arm-5, destructively interfere with each other, such that an optical signal may not be detected.

Unlike this, in the case in which a forward bias is applied between the first and second electrodes 105 and 150, a refractive index of the core layer 120 in the arm-4 region may be changed, which may change a phase of the optical signal moved in the arm-4 region. A sufficient bias voltage is applied between the first and second electrodes 105 and 150 so that the phase of the optical signal moved in the arm-4 region may be changed by π.

A method of operating an optical device in this case will be described below. An optical signal having a phase of 0 and an intensity of 1 may be input to an input port of the second waveguide WG2. This optical signal may be coupled from the arm-2 of the first directional coupling region DC-1 to the arm-1 thereof to thereby be split into a first optical signal having a phase of π/2 and an intensity of ½ in the arm-1 and a second optical signal having a phase of 0 and an intensity of ½ in the arm-2. Then, the first optical signal may pass through the Mach-Zehnder interference region MZ through the arm-3, and the second optical signal may pass through the Mach-Zehnder interference region MZ through the arm-4. In this case, the first optical signal passing through the arm-3 may be maintained in a state in which it has the phase of π/2 and the intensity of ½. Meanwhile, as described above, since the sufficient bias voltage is applied between the first and second electrodes 105 and 150 so that the phase of the optical signal moved in the arm-4 region may be changed by π, the second optical signal moved in the arm-4 may have a phase of π and an intensity of ½. Then, in the second directional coupling region DC-2, the first optical signal (having the phase of π/2 and the intensity of ½) is coupled from the arm-5 to the arm-6, such that a signal having a phase of π obtained by adding π/2 to the phase of the first optical signal and an intensity of ¼ may be transferred in the arm-6 and a signal having a phase of π/2 and an intensity of ¼ may remain in the arm-5. Meanwhile, the second optical signal (having the phase of π and the intensity of ½) is coupled from the arm-6 to the arm-5, such that a signal having a phase of 3π/2 obtained by adding π/2 to the phase of the second optical signal and an intensity of ¼ may be transferred in the arm-5 and a signal having a phase of π and an intensity of ¼ may remain in the arm-6. As a result, at the output port output-1 of the first waveguide WG1 connected to the arm-5, the optical signal having the phase of π/2 and the intensity of ¼, which remains in the arm-5, and the optical signal having 3π/2 and the intensity of ¼, which is transferred from the arm-6, destructively interfere with each other, such that an optical signal may not be detected. Meanwhile, at the output port output-2 of the second waveguide WG2 connected to the arm-6, the optical signal having the phase of π and the intensity of ¼, which remains in the arm-6, and the optical signal having the phase of π and the intensity of ¼, which is transferred from the arm-5, constructively interfere with each other, such that an optical signal having a phase of π and an intensity of ½ may be detected.

This optical device may be used as a modulator as well as a 1×2 optical switch.

### Fourth Exemplary Embodiment

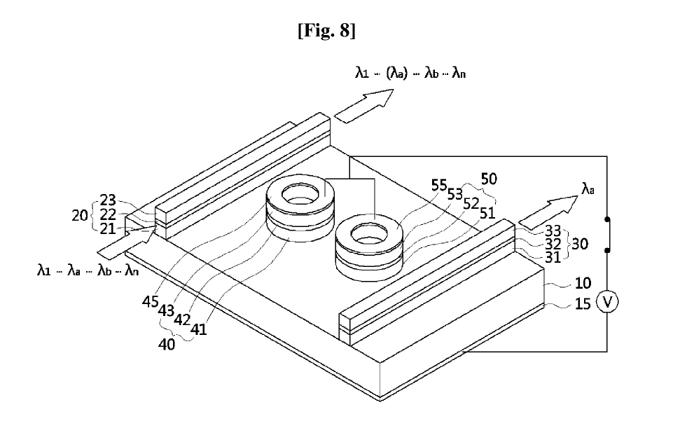

FIG. 5 is a perspective view showing an optical device according to a fourth exemplary embodiment of the present invention.

Referring to FIG. 5, a substrate 10 is provided. The substrate 10 may be a conductor substrate or a semiconductor substrate. The conductor substrate may be a metal substrate, and the semiconductor substrate may be a GaAs substrate, a GaN substrate, an InP substrate, or a GaP substrate.

A first waveguide 20 extended in one direction may be disposed on the substrate 10. In addition, a second waveguide 40, a third waveguide 50, and a fourth waveguide 30 may be sequentially positioned at a side of the first waveguide 20 on the substrate 10. The first waveguide 20 may be a transmission waveguide, the second waveguide 40 may be a first resonant ring having a closed ring shape, the third waveguide 50 may be a second resonant ring also having a closed ring shape, and the fourth waveguide 30 may be a dropping waveguide.

Here, the dropping waveguide 30 extended on the substrate 10 may be disposed at an opposite side of the transmission waveguide 20 based on the first resonant ring 40, and the second resonant ring 50 may be positioned between the first resonant ring 40 and the dropping waveguide 30.

The first resonant ring 40 may include first and second cladding layers 41 and 43 and a core layer 42 disposed between the first and second cladding layers 41 and 43 and having a refractive index larger than those of the first and second cladding layers 41 and 43. As an example, the first cladding layer 41, the core layer 42, and the second cladding layer 43 may be sequentially stacked and positioned on the substrate 10. The first resonant ring 40 may be a double hetero junction diode. Specifically, the first cladding layer 41 may be a first conductive semiconductor layer, the second cladding layer 43 may be a second conductive semiconductor layer, and the core layer 42 may be an undoped semiconductor layer. In addition, the first cladding layer 41 may be an n-type semiconductor layer, and the second cladding layer 43 may be a p-type semiconductor layer. The first and second cladding layers 41 and 43 may have a thickness of about 1 to 2 μm regardless of each other. The core layer 42 may have a thickness of about 0.1 μm to 1 μm. A first resonant ring electrode 15 and a second resonant ring electrode 45 may be connected to the first and second cladding layers 41 and 43, respectively.

The second resonant ring 50 may have a structure that is the same as or similar to that of the first resonant ring 40. Specifically, the second resonant ring 50 may include first and second cladding layers 51 and 53 and a core layer 52 disposed between the first and second cladding layers 51 and 53 and having a refractive index larger than those of the first and second cladding layers 51 and 53. The second resonant ring 50 may also be a double hetero junction diode. Specifically, the first cladding layer 51, the core layer 52, and the second cladding layer 53 may be sequentially stacked and positioned on the substrate 10. Here, the first cladding layer 51 may be a first conductive semiconductor layer, the second cladding layer 53 may be a second conductive semiconductor layer, and the core layer 52 may be an undoped semiconductor layer. In addition, the first cladding layer 51 may be an n-type semiconductor layer, and the second cladding layer 53 may be a p-type semiconductor layer. The first resonant ring electrode 15 and a third resonant ring electrode 55 may be connected to the first and second cladding layers 51 and 53, respectively. Here, the first resonant ring electrode 15 may be commonly connected to the first cladding layer 41 of the first resonant ring 40 and the first cladding layer 51 of the second resonant ring 50. The first resonant ring electrode 15 may be disposed beneath the substrate 10, which is a conductor or a semiconductor, and be commonly connected to the first cladding layers 41 and 51 through the substrate 10.

As described above, the core layer 42 included in the first resonant ring 40 has a refractive index larger than those of the first and second cladding layers 41 and 43. In addition, the core layer 52 included in the second resonant ring 50 has a refractive index larger than those of the first and second cladding layers 51 and 53. Therefore, the resonant rings 40 and 50 may confine light resonated along circumferences thereof in the core layers 42 and 52.

The first and second resonant rings 40 and 50 may resonate a maximum resonant wavelength satisfying a resonant condition, which is the following Equation, and a wavelength having a predetermined distribution from the maximum resonant wavelength.

mλᵣ=2πRn_{eff} [Equation 5]

In Equation 5, m indicates an integer, λᵣ indicates a maximum resonant wavelength, R indicates a radius of a resonant ring, and n_{eff} indicates an effective refractive index of a core layer inclined in the resonant ring. Here, λᵣ may be a resonant wavelength having a maximum intensity among resonant wavelengths having a predetermined distribution (for example, a modified Lorentian distribution or a box-like distribution).

Effective refractive indices (n_{eff}) of the core layers 42 and 52 may depend on a density of free carriers in the core layers 42 and 52. As an example, when the density of the free carriers in the core layers 42 and 52 is increased, the effective refractive indices of the core layers 42 and 52 may be decreased. On the contrary, when the density of the free carriers in the core layers 42 and 52 is decreased, the effective refractive indices of the core layers 42 and 52 may be increased. The density of the free carriers in the core layers 42 and 52 may depend on bias voltages applied to the resonant rings 40 and 50. As an example, when forward biases are applied to the resonant rings 40 and 50, electrons or holes are injected into the core layers 42 and 52, such that the density of the free carriers may be increased. On the contrary, when reverse biases are applied to the resonant rings 40 and 50, depletion regions in the core layers 42 and 52 are increased, such that the density of the free carriers may be decreased.

As described above, the effective refractive indices (n_{eff}) of the core layers 42 and 52 may depend on the bias voltages applied to the resonant rings 40 and 50. Therefore, the maximum resonant wavelengths (λᵣ) of the resonant rings 40 and 50 may depend on the bias voltages applied to the resonant rings 40 and 50. For example, when the forward voltages are applied to the resonant rings 40 and 50, the effective refractive indices of the core layers 42 and 52 may be decreased, and when the reverse voltages are applied to the resonant rings 40 and 50, the effective refractive indices of the core layers 42 and 52 may be increased. Therefore, the maximum resonant wavelengths (λᵣ) may be changed.

The main waveguide 20 may include first and second cladding layers 21 and 23 and a core layer 22 disposed between the first and second cladding layers 21 and 23. As an example, the first cladding layer 21, the core layer 22, and the second cladding layer 23 may be sequentially stacked and positioned on the substrate 10. The core layer 22 may have a refractive index larger than those of the cladding layers 21 and 23. Therefore, an optical signal input at an input port of the main waveguide 20 may be confined in the core layer 22 and be transferred to an output port of the main waveguide 20. Here, the optical signal may be propagated while being totally reflected on an interface between the core layer 22 and the cladding layers 21 and 23. The first and second cladding layers 21 and 23 and the core layer 22 may be semiconductor layers. As an example, the main waveguide 20 may also be a double hetero junction diode. Specifically, the first cladding layer 21 may be a first conductive semiconductor layer, the core layer 22 may be an undoped semiconductor layer, and the second cladding layer 23 may be a second conductive semiconductor layer. As an example, the first cladding layer 21 may be an n-type semiconductor layer, and the second cladding layer 23 may be a p-type semiconductor layer.

The dropping waveguide 30 may have a configuration that is the same as or similar to that of the main waveguide 20. For example, the dropping waveguide 30 may also include first and second cladding layers 31 and 33 and a core layer 32 disposed between the first and second cladding layers 31 and 33 having a refractive index larger than those of the first and second cladding layers 31 and 33. In addition, the main waveguide 20 and the dropping waveguide 30 may have the same layer structure as those of the first and second resonant rings 40 and 50. In this case, a manufacturing process becomes easy. However, the main waveguide 20 and the dropping waveguide 30 are not limited to having the above-mentioned structure, but may also have a structure different from those of the first and second resonant rings 40 and 50. In addition, the main waveguide 20 and the dropping waveguide 30 may also have different structures.

In the case in which the core layers 22, 42, 52, and 32 each included the main waveguide 20, the dropping waveguide 30, and the first and second resonant rings 40 and 50 are semiconductor layers, optical signals propagated through the core layers 22, 42, 52, and 32 may have wavelengths corresponding to energy smaller than bandgap energy of the core layers 22, 42, 52, and 32. In this case, since the optical signals may not be absorbed by the core layers 22, 42, 52, and 32, loss of the optical signal propagated through the core layers 22, 42, 52, and 32 may be decreased. The optical signal may have a wavelength of 700 nm or more. Specifically, the optical signal may have a wavelength of 1000 nm or more. More specifically, the optical signal may have a wavelength of 1300 nm to 1600 nm. As the most specific example, the optical signal may have a wavelength of about 1300 nm or about 1550 nm mainly used in a wired optical communication field. However, the present invention is not limited thereto.

The core layers 22, 32, 42, and 52 and the cladding layers 21, 23, 31, 33, 41, 43, 51, and 53 may be semiconductor layers made of a compound such as GaAs/AlGaAs, AlₓGa₁₋ₓAs/Al_{y}Ga_{1-y}As (x>y, 0<x<1, and 0<y<1), InGaAs/InAlAs, InGaAsP/InP, In_{y}Ga_{1-y}As₁₋ₓPₓ/In_{b}Ga_{1-b}As₁₋ₐPₐ (x<a, 0<x<1, 0<y<1, 0<a<1, and 0<b<1), GaN/InGaN, AlInN/GaN, and the like, or a combination thereof. Specifically, the core layers 22, 32, 42, and 52 and the cladding layers 21, 23, 31, 33, 41, 43, 51, and 53 may be made of GaAs/AlGaAs in which comparatively expensive In is not used.

Meanwhile, a distance between the main waveguide 20 and the first resonant ring 40, a distance between the first and second resonant rings 40 and 50, and a distance between the second resonant ring 50 and the dropping waveguide 30 may be narrow enough to easily generate coupling therebetween. As an example, the distances may be several hundred nm, specifically, 300 nm or less.

Although the case in which the substrate 10 is a conductive substrate has been described in the exemplary embodiments of the present invention, the present invention is not limited thereto. That is, the substrate 10 may be an insulating substrate. In this case, the first resonant ring electrode 15 may also be disposed between the substrate 10 and the first cladding layers 41 and 51.

In addition, electrodes may also be formed beneath the first cladding layers 21 and 31 of the waveguides 20 and 30 and on the second cladding layers 23 and 33 thereof, respectively. In this case, biases may be applied to the waveguides 20 and 30 to change the effective refractive indices of the core layers 22 and 32 included in the waveguides 20 and 30. Therefore, ranges of wavelengths propagated by the waveguides 20 and 30 may be changed.

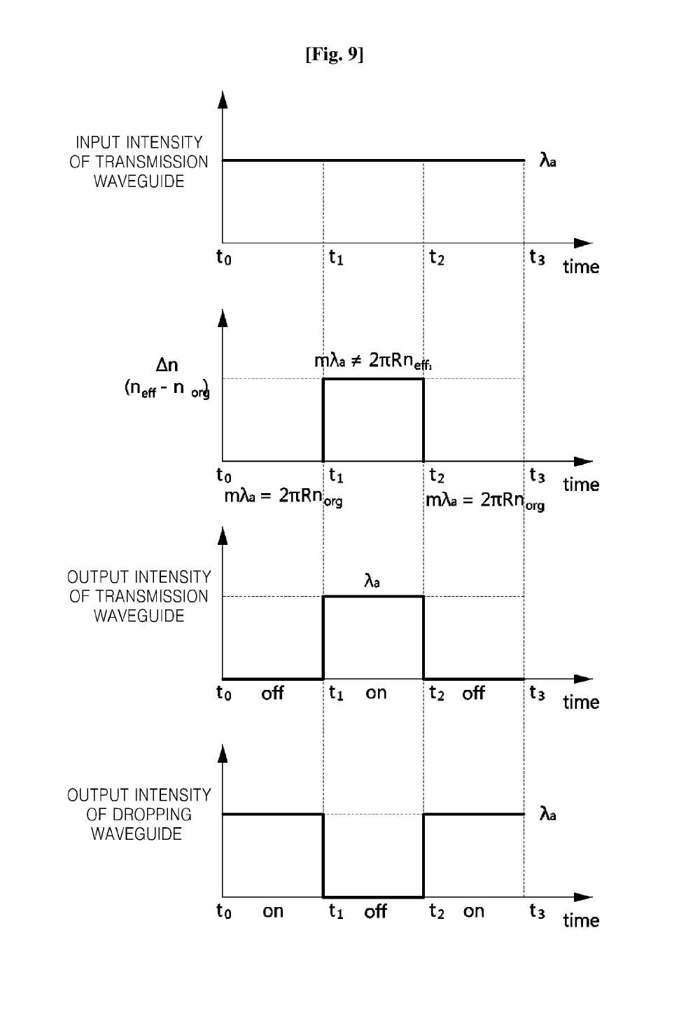

FIGS. 6A and 6B are cross-sectional views taken along the cut line II-II′ of FIG. 1 for each process step and showing a method of manufacturing an optical device according to the exemplary embodiment of the present invention. See contents described with reference to FIG. 5 with respect to specific examples of materials.

Referring to FIG. 6A, a first cladding layer 1, a core layer 2, and a second cladding layer 3 may be sequentially stacked on a substrate 10. The first cladding layer 1, the core layer 2, and the second cladding layer 3 may be formed on the substrate 10 by a chemical vapor deposition (CVD) method. As an example, the first cladding layer 1, the core layer 2, and the second cladding layer 3 may be epitaxially grown by metal organic chemical vapor deposition (MOCVD), molecular beam epitaxy (MBE), or the like.

Referring to FIG. 6B, the second cladding layer 3, the core layer 2, and the first cladding layer 1 may be sequentially etched to form the transmission waveguide 20, the first resonant ring 40, the second resonant ring 50, and the dropping waveguide 30. Then, an insulating film 60 covering the transmission waveguide 20, the first resonant ring 40, the second resonant ring 50, the dropping waveguide 30 may be formed and be then etched back until the second cladding layers 23, 43, 53, and 33 are exposed. The insulating film 60 may be made of benzocyclobutene (BCB).

The first electrode 15 may be formed on a lower surface of the substrate 10. In addition, the second electrodes 45 and 55 may be formed on the second cladding layers 43 and 53 of the resonant rings 40 and 50, respectively.

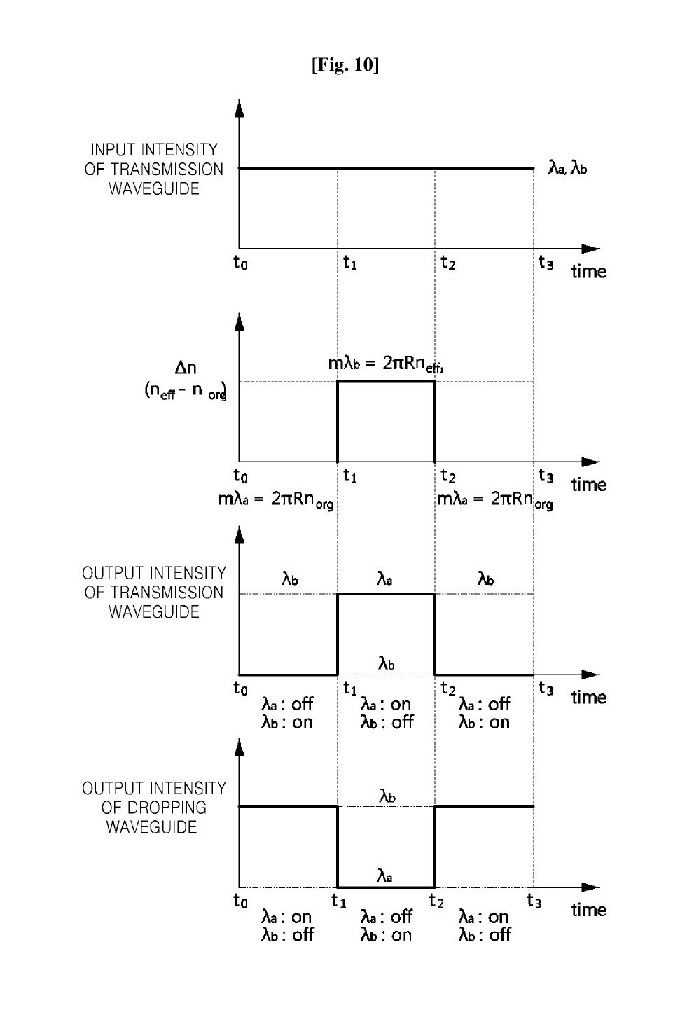

FIGS. 7 and 8 are perspective views showing a method of operating an optical device shown in FIG. 1.

Referring to FIG. 7, a series of optical signals λ₁ . . . λₐ . . . λ_{b} . . . λₙ may be input to an input port of the transmission waveguide 20. These optical signals λ₁ . . . λₐ . . . λ_{b} . . . λₙ may be propagated along the main waveguide 20. Specifically, the optical signal λ₁ . . . λₐ . . . λ_{b} . . . λₙ may be confined in the core layer 22 having a refractive index higher than those of the cladding layers 21 and 23 and be propagated along the core layer 22.

Meanwhile, bias voltages are not applied to the first and second resonant rings 40 and 50. In this case, effective refractive indices (n_{eff}) of the core layers 42 and 52 included in the resonant rings 40 and 50 may be refractive indices of materials themselves configuring the core layers 42 and 52, that is, original refractive indices (n_{org}). In this case, λ_{b} satisfying the above Equation 1 among the optical signals propagated along the transmission waveguide 20 may be coupled to the first resonant ring 40. In addition, λ_{b} resonated along a circumference of the first resonant ring 40 may be sequentially coupled to the second resonant ring 50 and the dropping waveguide 30. As a result, λ_{b} may be output to an output port of the dropping waveguide 30.

Here, in a region in which the transmission waveguide 20 and the first resonant ring 40 are adjacent to each other, a direction of light propagated in the transmission waveguide 20 and a direction D1 of light resonated along the circumference of the first resonant ring 40 may be in parallel with each other. Further, in a region in which the first and second resonant rings 40 and 50 are adjacent to each other, the direction D1 of the light resonated along the circumference of the first resonant ring 40 and a direction D2 of light resonated along a circumference of the second resonant ring 50 may be in parallel with each other. This may also be similar between the second resonant ring 50 and the dropping waveguide 30. For example, in the case in which the optical signal is propagated in the transmission waveguide 20 in a direction shown in FIG. 7, λ_{b} may be resonated along the circumference of the first resonant ring 40 in a clockwise direction D1. Then, λ_{b} may be coupled to the second resonant ring 50 to thereby be resonated along the circumference of the second resonant ring 50 in a counterclockwise direction D2. Thereafter, λ_{b} may be again coupled to the dropping waveguide 30, be propagated along the dropping waveguide 30, and be then output to the output port of the dropping waveguide 30. In this case, the output port of the dropping waveguide 30 may be positioned in an opposite direction to the input port of the transmission waveguide 20. Meanwhile, wavelengths other than λ_{b} may be output from the output port of the transmission waveguide 20.

Referring to FIG. 8, a series of optical signals λ₁ . . . λₐ . . . λ_{b} . . . λₙ may be input to an input port of the transmission waveguide 20, as described with reference to FIG. 7.

Meanwhile, bias voltages are applied to the first and second resonant rings 40 and 50. The bias voltages applied to the first and second resonant rings 40 and 50, respectively, may be the same as each other. In this case, effective refractive indices (n_{eff}) of the core layers 42 and 52 included in the resonant rings 40 and 50 may be changed to be different from original refractive indices (n_{org}) of the core layers 42 and 52. As an example, when the forward biases are applied to the first and second resonant rings 40 and 50, the effective refractive indices (n_{eff}) of the core layers 42 and 52 may be decreased as compared with the refractive indices (n_{org}) of material themselves configuring the core layers 42 and 52.

When the bias voltages are not applied to the first and second resonant rings 40 and 50, λ_{b} that has been resonated in the first and second resonant rings 40 and 50 may no longer be resonated in the first and second resonant rings 40 and 50. As a result, λ_{b} may be output together with other optical signals to the output port of the main waveguide 20 and may no longer be output at the output port of the dropping waveguide 30.

Meanwhile, due to the change in the effective refractive indices (n_{eff}) of the core layers 42 and 52 included in the resonant rings 40 and 50 by the application of the biases, the resonant rings 40 and 50 may resonate λₐ satisfying the above Equation 1. As a result, λₐ may be output to the output port of the dropping waveguide 30, and other wavelengths other than λₐ may be output at the output port of the transmission waveguide 20.

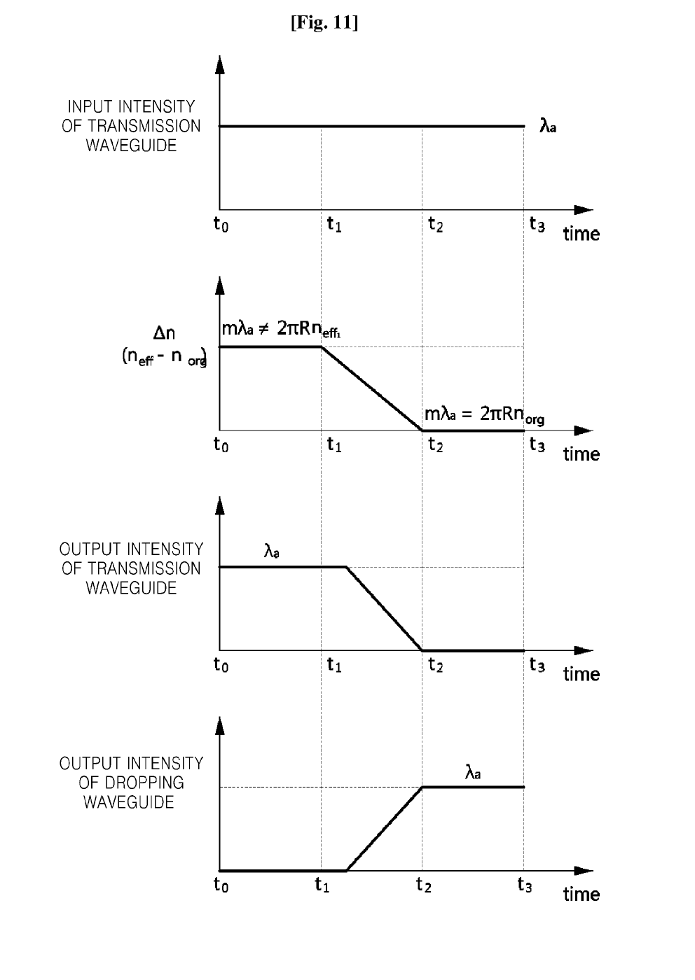

FIG. 9 is a graph showing that the optical device described with reference to FIGS. 5 to 8 is operated as an optical switch or an optical modulator.

Referring to FIGS. 5 and 9, a wavelength of λₐ having a predetermined intensity is input to the transmission waveguide 20.

In a period t₀ to t₁, electric fields are not applied across the first and second resonant rings 40 and 50. Therefore, the effective refractive indices (n_{eff}) of the core layers 42 and 52 in the resonant rings 40 and 50 may be the same as the original refractive indices (n_{org}). Meanwhile, λₐ and the original refractive indices (n_{org}) satisfy the above Equation 1, which is a resonant condition. As a result, in the period t₀ to t₁, λₐ input to the transmission waveguide 20 may be sequentially coupled to the first resonant ring 40, the second resonant ring 50, and the dropping waveguide 30, and be then output to the output port of the dropping waveguide 30. In this case, λₐ is not output at the output port of the transmission waveguide 20.

However, in the period t₀ to t₁, the biases are applied to the first and second resonant rings 40 and 50 to change the effective refractive indices of the core layers 42 and 52 into n_{eff1}. Therefore, since λₐ does not satisfy the resonant condition any more, λₐ may not be coupled to the first resonant ring 40. As a result, λₐ may be output at the output port of the transmission waveguide 20 and may not be output at the output port of the dropping waveguide 30.

In a period t₂ to t₃, the biases are not applied to the first and second resonant rings 40 and 50. As a result, similar to the period t₀ to t₁, λₐ input to the transmission waveguide 20 may be output to the output port of the dropping waveguide 30 and may not be output at the output port of the transmission waveguide 20.

When a state in which the biases are applied to the first and second resonant rings 40 and 50 as in the period t₀ to t₁ is continued, the optical device may serve as an optical switch switching light from the transmission waveguide 20 to the dropping waveguide 30.

Meanwhile, when the state in which the biases are applied to the first and second resonant rings 40 and 50 and the state in which the biases are not applied to the first and second rings 40 and 50 are repeated as in the periods t₀ to t₁, t₁ to t₂, and t₂ to t₃, since intensities of light dropped in the transmission waveguide 20 and the dropping waveguide 30 may be changed depending on a time, the optical device may serve as an optical modulator.

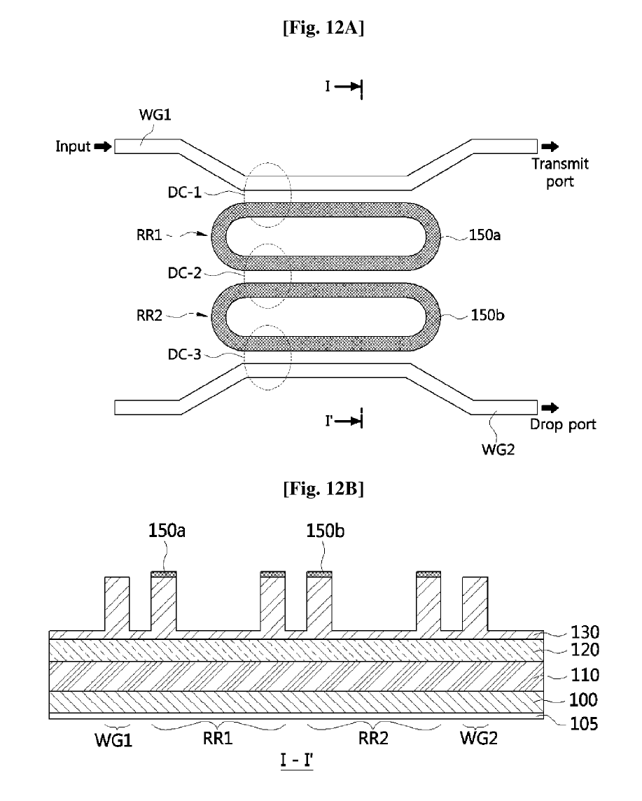

FIG. 10 is a graph showing that the optical device described with reference to FIGS. 5 to 8 is operated as an optical splitter.

Referring to FIGS. 5 and 10, wavelengths of λₐ and λ_{b} having a predetermined intensity are input to the transmission waveguide 20.

In a period t₀ to t₁, the biases are not applied to the first and second resonant rings 40 and 50. Therefore, the effective refractive indices (n_{eff}) of the core layers 42 and 52 in the resonant rings 40 and 50 may be the same as the original refractive indices (n_{org}). Meanwhile, λₐ and the original refractive indices (n_{org}) satisfy a resonant condition. As a result, in the period t0 to t1, λₐ input to the transmission waveguide 20 may be sequentially coupled to the first resonant ring 40, the second resonant ring 50, and the dropping waveguide 30, and be then output to the output port of the dropping waveguide 30. In this case, λₐ is not output and only λ_{b} may be output, at the output port of the transmission waveguide 20.

However, in the period t₀ to t₁, the biases are applied to the first and second resonant rings 40 and 50 to change the effective refractive indices of the core layers 42 and 52 into n_{eff1}. Therefore, since λₐ does not satisfy the resonant condition any more, λₐ is not coupled to the first resonant ring 40. On the contrary, λ_{b} satisfying the resonant condition may be sequentially coupled to the first resonant ring 40, the second resonant ring 50, and the dropping waveguide 30. As a result, λₐ may be output at the output port of the transmission waveguide 20, and λ_{b} may be output at the output port of the dropping waveguide 30.

In a period t₂ to t₃, the biases are not again applied to the first and second resonant rings 40 and 50. As a result, similar to the period t₀ to t₁, λₐ input to the transmission waveguide 20 may be output to the output port of the dropping waveguide 30, and λ_{b} input to the transmission waveguide 20 may be output at the output port of the transmission waveguide 20.

When the state in which the biases are applied to the first and second resonant rings 40 and 50 is continued as in the period t₀ to t₁ or when the state in which the biases are not applied to the first and second resonant rings 40 and 50 is continued as in the periods t₀ to t₁ and t₂ to t₃, since the optical device may output one of λₐ and λ_{b} input to the transmission waveguide 20 to the output port of the dropping waveguide 30 and output the other to the output port of the transmission waveguide 20, the optical device may serve as an optical splitter.

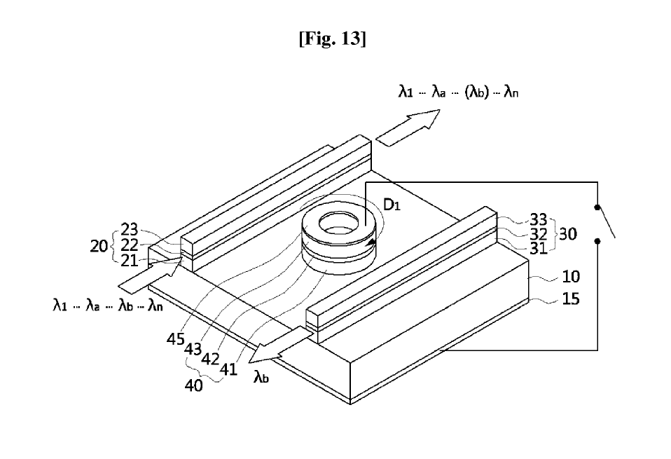

FIG. 11 is a graph showing that the optical device described with reference to FIGS. 5 to 8 is operated as an optical attenuator.

Referring to FIGS. 5 and 8, a wavelength of λₐ having a predetermined intensity is input to the transmission waveguide 20.

In a period t₀ to t₁, the biases are applied to the first and second resonant rings 40 and 50 to change the effective refractive indices of the core layers 42 and 52 into n_{eff1}. Since λₐ does not satisfy the resonant condition, λₐ may not be coupled to the first resonant ring 40. As a result, λₐ may be output at the output port of the transmission waveguide 20 and may not be output at the output port of the dropping waveguide 30.

In a period t₁ to t₂, the biases applied to the first and second resonant rings 40 and 50 are gradually decreased to arrive at 0. In this case, the effective refractive indices (n_{eff}) of the core layers 42 and 52 in the resonant rings 40 and 50 may be gradually changed from n_{eff1} to n_{org}. As described above, since λᵣ satisfying the above Equation 1 is a resonant wavelength having a maximum intensity among resonant wavelengths having a predetermined distribution (for example, a modified Lorentian distribution or a box-like distribution) with respect to the effective refractive index, when the effective refractive indices (n_{eff}) of the core layers 42 and 52 are gradually changed from n_{eff1} to n_{org}, an intensity at which λₐ is coupled to the first resonant ring 40 may be gradually increased. As a result, the intensity of λₐ may be gradually decreased at the output port of the transmission waveguide 20 and be gradually increased at the output port of the dropping waveguide 30.

In a period t₂ to t₃, the biases are not again applied to the first and second resonant rings 40 and 50. As a result, λₐ input to the transmission waveguide 20 may be output to the output port of the dropping waveguide 30 and may not be output at the output port of the transmission waveguide 20.

When the bias values applied to the first and second resonant rings 40 and 50 are gradually changed depending on a time as in the period t₁ to t₂, the optical device may serve as an optical attenuator in which an intensity of light output at the transmission waveguide 20 or the dropping waveguide 30 is gradually changed depending on the time.

### Fifth Exemplary Embodiment

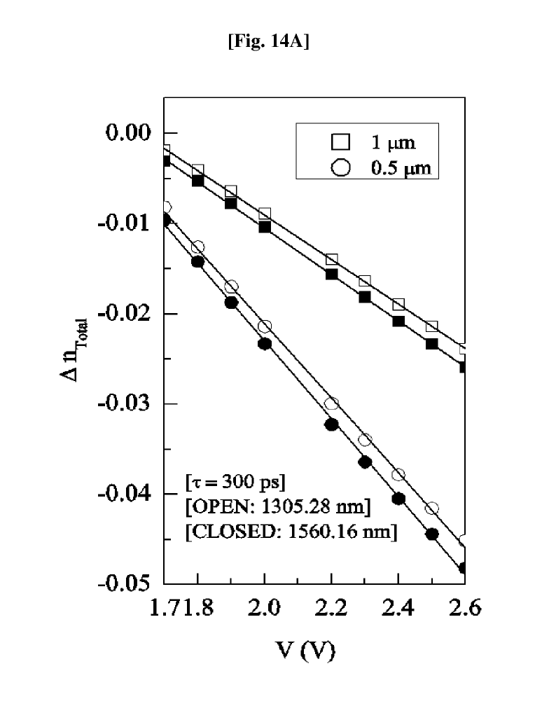

FIG. 12A is a plan view of an optical device according to a fifth exemplary embodiment of the present invention, and FIG. 12B is a cross-sectional view taken along the cut line I-I′ of FIG. 12A. The optical device according to the present embodiment may be an optical device including a resonant ring and a directional coupler. The optical device according to the present embodiment may be similar to the optical device according to the fourth exemplary embodiment of the present invention except for a structure to be described below. However, although the case in which the optical device according to the present embodiment has a cross-sectional structure similar to that of the optical device according to the first exemplary embodiment of the present invention, the present invention is not limited thereto. That is, the optical device according to the present embodiment may also have a cross-sectional structure similar to that of the optical device according to the fourth exemplary embodiment of the present invention.

Referring to FIGS. 12A and 12B, a substrate 100 is provided. A first electrode 105 may be disposed beneath the substrate 100. Meanwhile, a first cladding layer 110, a core layer 120, and a second cladding layer 130 are sequentially disposed on the substrate 100. The second cladding layer 130 has regions having different thicknesses. The above-mentioned structure may be manufactured even though a semiconductor material is etched at a thickness thinner as compared with the fourth exemplary embodiment of the present invention.

Since the possibility that a thick region of the second cladding layer 130 will confine light thereunder is higher as compared with other regions of the second cladding layer 130, the thick region of the second cladding layer 130 may be defined as an optical waveguide. Specifically, the thick region of the second cladding layer 130 may define a transmission waveguide WG1, a first resonant ring RR1, a second resonant ring RR2, and a dropping waveguide WG2. Each of the first and second resonant rings RR1 and RR2 includes a pair of straight lines that is in parallel with each other and a pair of curves connecting both end portions of the straight lines to each other, such that it may have a lace-like structure. An interval between one side straight line region included in the first resonant ring RR1 and the transmission waveguide WG1, an interval between one side straight line region included in the first resonant ring RR1 and one side straight line region included in the second resonant ring RR2, and an interval between one side straight line region included in the second resonant ring RR2 and the dropping waveguide WG2 may be narrow enough to generate coupling therebetween due to an interaction of optical fields therebetween.

Second electrodes 150a and 150b may be disposed on second cladding layers 130 of the first and second resonant rings RR1 and RR2, respectively. The core layer 120 may have a refractive index larger than those of the first and second cladding layers 110 and 130. Therefore, the light may be confined in the core layer 120 due to a difference in the refractive index. In summary, the light may be confined in the core layer 120 under the thick region of the second cladding layer 130.

An operation principle of the optical device will be described below. Similar to the fourth exemplary embodiment of the present invention, in the case in which a bias voltage is not applied between the first electrode 105 and the second electrodes 150a and 150b, an optical signal input through an input port of the transmission waveguide WG1 may be sequentially coupled to the first resonant ring RR1 and the second resonant ring RR2 and be then output to an output port Drop port of the dropping waveguide WG2. However, in the case in which the bias voltage is applied between the first electrode 105 and the second electrodes 150a and 150b, since refractive indices of core layers included in the first and second resonant rings are changed, a coupling coefficient between the transmission waveguide and the first resonant ring, a coupling coefficient between the first and second resonant rings, and a coupling coefficient between the second resonant ring and the dropping waveguide are changed, such that the optical signals may not be coupled therebetween. As a result, the optical signals input through the input port of the transmission waveguide WG1 may be output to an output port Transmit port of the transmission waveguide WG1.

### Sixth Exemplary Embodiment

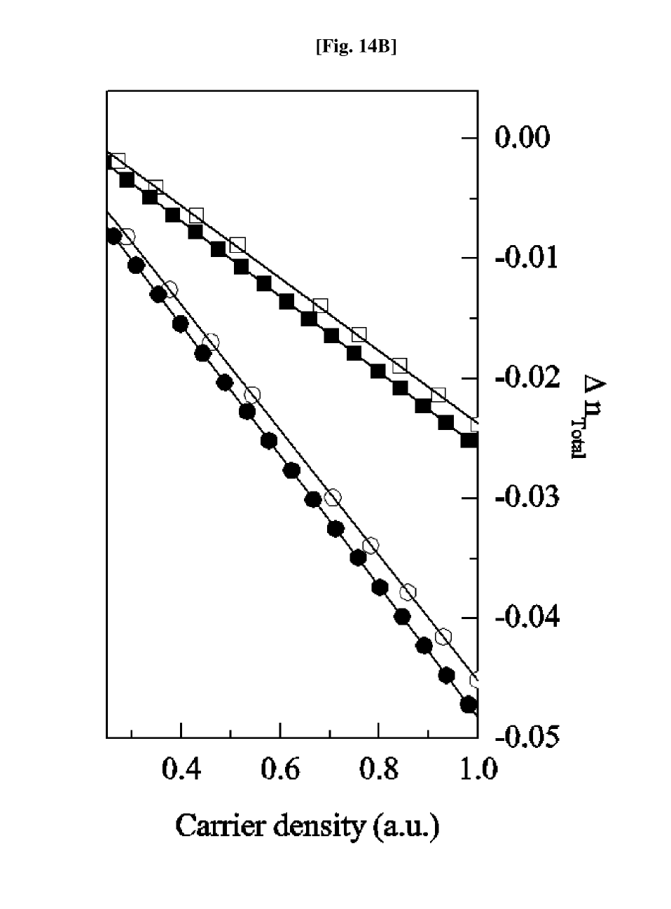

FIG. 13 is a perspective view showing an optical device according to another exemplary embodiment of the present invention. The optical device according to the present embodiment is similar to the optical device described with reference to FIGS. 5 to 11 except for a structure to be described below.

Referring to FIG. 13, a transmission waveguide 20 extended in one direction may be disposed on the substrate 10. In addition, a first resonant ring 40 may be positioned at a side of the transmission waveguide 20 on the substrate 10. A dropping waveguide 30 extended on the substrate 10 may be disposed at an opposite side of the transmission waveguide 20 based on the first resonant ring 40. Unlike the optical device described with reference to FIG. 1, an odd resonant ring 40, specifically, one resonant ring 40 is disposed between the transmission waveguide 20 and the dropping waveguide 30.

In this optical device, when a series of optical signals λ₁ . . . λₐ . . . λ_{b} . . . λₙ are input to an input port of the transmission waveguide 20, in the case in which a bias voltage is not applied to the resonant ring 40, λ_{b} satisfying a resonant condition among optical signals propagated along the transmission waveguide 20 may be sequentially coupled to the resonant ring 40 and the dropping waveguide 30 and be then output to an output port of the dropping waveguide 30.

Here, in a region in which the transmission waveguide 20 and the resonant ring 40 are adjacent to each other, a direction of light propagated in the transmission waveguide 20 and a direction D1 of light resonated along a circumference of the resonant ring 40 may be in parallel with each other, which may also be similar between the resonant ring 40 and the dropping waveguide 30. For example, in the case in which the optical signal is propagated in the transmission waveguide 20 in a direction shown in FIG. 13, λ_{b} may be resonated along the circumference of the first resonant ring 40 in a clockwise direction D1. Then, λ_{b} may be again coupled to the dropping waveguide 30, be propagated along the dropping waveguide 30, and be then output to an output port of the dropping waveguide 30. In this case, the output port of the dropping waveguide 30 may be positioned in the same opposite direction as the input port of the transmission waveguide 20. Meanwhile, wavelengths other than λ_{b} may be output from the output port of the transmission waveguide 20.

As described above, the semiconductor optical devices described in the first to sixth exemplary embodiments of the present invention may be used to switch the optical signal, modulate the optical signal, and adjust an intensity of the optical signal. To this end, a carrier density is adjusted through the supply of the bias to change the refractive index of the semiconductor material, thereby switching the optical signal, modulating the optical signal, and adjusting the intensity of the optical signal. The semiconductor devices using the above-mentioned principle may be used for an optical communication system, optical interconnection, optical computing, optical signal processing, and the like.

Hereinafter, an exemplary example will be provided in order to assist in the understanding of the present invention. However, the following example is only to assist in the understanding of the present invention, and the present invention is not limited to the following example.

### Preparation Example 1

### Manufacturing of Optical Device

An n-type Al_{0.3}Ga_{0.7}As layer having a thickness of about 1.5 μm, an undoped GaAs layer, and a p-type Al_{0.3}Ga_{0.7}As layer having a thickness of about 1.5 μm were epitaxially grown on a GaAs substrate. The p-type Al_{0.3}Ga_{0.7}As layer, the undoped GaAs layer, and the n-type Al_{0.3}Ga_{0.7}As layer were sequentially etched to form a transmission waveguide 20 (See FIG. 5), a first resonant ring 40 (See FIG. 5), a second resonant ring 50 (See FIG. 5), and a dropping waveguide 30 (See FIG. 5) as shown in FIG. 5. Then, a first resonant ring electrode 15 (See FIG. 5) was formed on a lower surface of the substrate, and a second resonant ring electrode 45 (See FIG. 5) and a third resonant ring electrode 55 (See FIG. 5) were formed on p-type Al_{0.3}Ga_{0.7}As layers 43 and 53 (See FIG. 5) of the resonant rings.

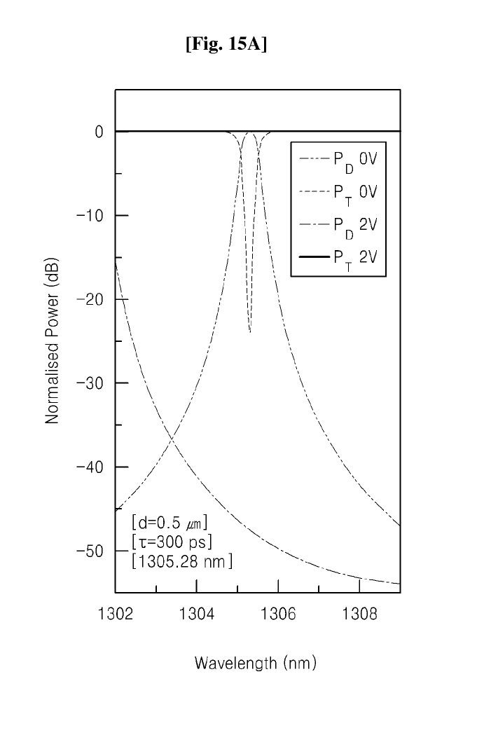

FIG. 14A is a graph showing a change in a refractive index for a bias voltage applied to each resonant ring of an optical device according to Preparation Example 1, and FIG. 14B is a graph showing a change in a refractive index for a carrier density generated when the bias voltage is applied to each resonant ring of the optical device according to Preparation Example 1. The change in the refractive index was measured in a state in which wavelengths of 1305.28 nm and 1560.16 nm are input to an input port of a transmission waveguide with respect to an optical device including an undoped GaAs layer having a thickness of 1 μm and an optical device including an undoped GaAs layer having a thickness of 0.5 μm.

Referring to FIGS. 14A and 14B, as a forward bias applied across the resonant ring is increased, a change amount (Δnₜₒₜₐₗ) in the refractive index, that is, a difference between an original refractive index and an effective refractive index was increased. In addition, when a carrier density is increased by the forward bias applied across the resonant ring, the change amount (Δnₜₒₜₐₗ) in the refractive index was increased. Here, it could be appreciated that since the change amount (Δnₜₒₜₐₗ) in the refractive index has a negative value, the effective refractive index is decreased as compared with the original refractive index.

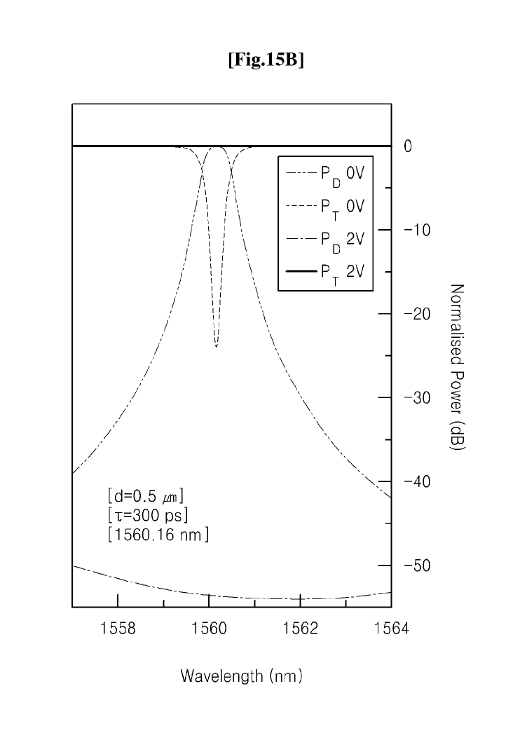

FIGS. 15A and 15B are graphs showing normalized intensities of wavelengths output from a transmission waveguide and a dropping waveguide for a series of wavelengths input to a transmission waveguide of the optical device according to Preparation Example 1, respectively.

Referring to FIG. 15A, a series of wavelengths of 1302 nm to 1309 nm were input to the transmission waveguide of the optical device according to Preparation Example 1.

It could be appreciated that in the case in which bias voltages are not applied to resonant rings of the optical device (0V), an output intensity at 1305.28 nm, which is a maximum wavelength satisfying a resonant condition, is decreased at an output port P_{T} of the transmission waveguide, but is increased at an output port P_{D} of the dropping waveguide. In addition, it could be appreciated that an output wavelength has a modified Lorentian distribution or a box-like distribution based on the maximum resonant wavelength.

Meanwhile, it could be appreciated that in the case in which a forward bias of 2V is applied to the resonant rings, an output density at the output port P_{D} of the dropping waveguide is gradually decreased in a wavelength range between 1302 nm to 1309 nm as compared with an output intensity at the output port P_{T} of the transmission waveguide. The reason is that the effective refractive indices of the core layers of the resonant rings are decreased to the forward bias of 2V applied to the resonant rings, such that the maximum resonant wavelength becomes shorter than 1305.28 nm.

Referring to FIG. 15B, a series of wavelengths of 1557 nm to 1564 nm were input to the transmission waveguide of the optical device according to Preparation Example 1.

It could be appreciated that in the case in which bias voltages are not applied to resonant rings of the optical device (0V), an output intensity at 1560.16 nm, which is a maximum wavelength satisfying a resonant condition, is decreased at an output port P_{T} of the transmission waveguide, but is increased at an output port P_{D} of the dropping waveguide. In addition, it could be appreciated that an output wavelength has a modified Lorentian distribution or a box-like distribution based on the maximum resonant wavelength.

Meanwhile, it could be appreciated that in the case in which a forward bias of 2V is applied to the resonant rings, an output density at the output port P_{D} of the dropping waveguide is gradually decreased in a wavelength range between 1557 nm to 1564 nm as compared with an output intensity at the output port P_{T} of the transmission waveguide. The reason is that the effective refractive indices of the core layers of the resonant rings are decreased to the forward bias of 2V applied to the resonant rings, such that the maximum resonant wavelength becomes shorter than 1560.16 nm.

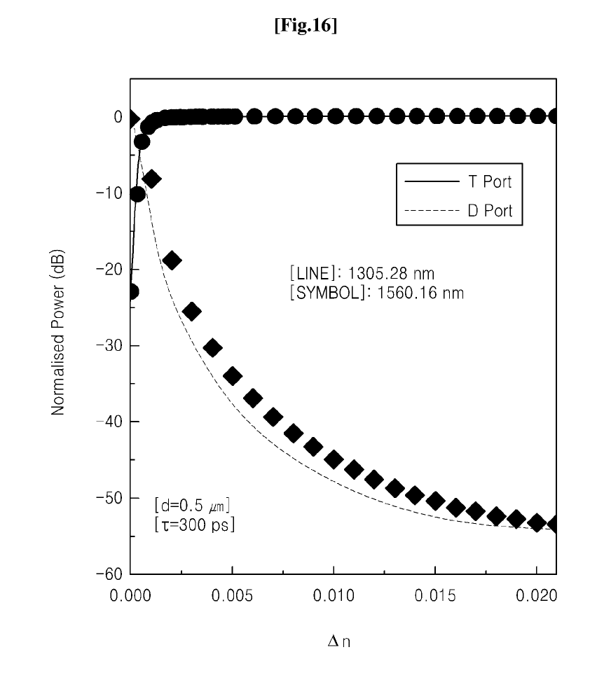

FIG. 16 is a graph showing normalized intensities of 1305.28 nm and 1560.16 nm, which are output wavelengths for a change amount in a refractive index when a bias is applied to the resonant rings of the optical device according to Preparation Example 1.

Referring to FIG. 16, it could be appreciated that in the case in which the biases are not applied to the resonant rings, such that a change amount in the refractive index is 0, maximum resonant wavelengths may be 1305.28 nm and 1560.16 nm, such that output intensities of 1305.28 nm and 1560.16 nm are at the minimum at an output port T port of the transmission wavelength, but are at the maximum at an output port D port of the dropping waveguide.

Meanwhile, in the case in which the biases are applied to the resonant rings, such that the change amount in the refractive index is gradually increased, a difference between the maximum resonant wavelength and 1305.28 nm or 1560.16 nm may be gradually increased. As a result, it could be appreciated that an amount by which 1305.28 nm or 1560.16 nm is coupled is decreased, such that the output intensities of 1305.28 nm and 1560.16 nm are gradually decreased at the output port D port of the dropping waveguide.

According to the exemplary embodiments of the present invention, the second waveguide having an effective refractive index changed depending on a bias voltage is disposed at a side of the first waveguide. Then, the bias voltage is changed to change the effective refractive index of the second waveguide, thereby making it possible to change a phase or a wavelength of light moved in the second waveguide. In addition, the optical device may be variously used as an optical switch, an optical modulator, or an optical splitter by an interaction between the first and second waveguides.

In addition, the second waveguide includes the first conductive semiconductor layer, the second conductive semiconductor layer, and the undoped semiconductor layer positioned between the first conductive semiconductor layer and the second conductive semiconductor layer, wherein the undoped semiconductor layer has a refractive index larger than those of the first conductive semiconductor layer and the second conductive semiconductor layer. In other words, the second waveguide has a PIN structure, which is a double hetero junction. Further, the first waveguide may also have the same layer configuration as that of the second waveguide. Since the optical device may be formed by a semiconductor process, it may be integrated together with other devices formed by the semiconductor process. In addition, the optical device has polarization independent characteristics, does not cause loss of an optical signal due to light absorption, and may perform various functions in a small area without being limited by an operation wavelength without a quantum well structure.

Hereinabove, although the exemplary embodiments of the present invention have been described in detail, the present invention is not limited to the above-mentioned exemplary embodiments, but may be variously modified and altered by those skilled in the art without departing from the scope and spirit of the present invention.

What is claimed is:

1. An optical device comprising:
a first waveguide extended in one direction;
a second waveguide positioned at a side of the first waveguide and including a first conductive semiconductor layer, a second conductive semiconductor layer, and an undoped semiconductor layer positioned between the first conductive semiconductor layer and the second conductive semiconductor layer, the undoped semiconductor layer having a refractive index larger than those of the first conductive semiconductor layer and the second conductive semiconductor layer; and
first and second electrodes connected to the first conductive semiconductor layer and the second conductive semiconductor layer of the second waveguide, respectively.

2. The optical device of claim 1, wherein the undoped semiconductor layer has bandgap energy larger than energy of light propagated by the optical device.

3. The optical device of claim 1, wherein the undoped semiconductor layer, the first conductive semiconductor layer, and the second conductive semiconductor layer are compound semiconductor layers.

4. The optical device of claim 3, wherein the undoped semiconductor layer, the first conductive semiconductor layer, and the second conductive semiconductor layer are made of GaAs/AlGaAs, AlₓGa₁₋ₓAs/Al_{y}Ga_{1-y}As (x>y, 0<x<1, and 0<y<1). InGaAs/InAlAs, InGaAsP/InP, In_{y}Ga_{1-y}As₁₋ₓPₓ/In_{b}Ga_{1-b}As₁₋ₐPₐ (x<a, 0<x<1, 0<y<1, 0<a<1, and 0<b<1), GaN/InGaN, AlInN/GaN, or a combination thereof.

5. The optical device of claim 1, wherein the first waveguide includes a first cladding layer, a second cladding layer, and a core layer positioned between the first and second cladding layers, and
the core layer has a refractive index larger than those of the first and second cladding layers.

6. The optical device of claim 5, wherein the first cladding layer is a first conductive semiconductor layer,
the core layer is an undoped semiconductor layer, and
the second cladding layer is a second conductive semiconductor layer.

7. The optical device of claim 1, wherein one end of the first waveguide and one end of the second waveguide are coupled to each other and the other end of the first waveguide and the other end of the second waveguide are coupled to each other, and
an interval between the first and second waveguides in regions in which one ends of the first and second waveguides are coupled to each other and the other ends of the first and second waveguides are coupled to each other is too large to generate coupling therebetween.

8. The optical device of claim 1, wherein an interval between the first and second waveguides in a partial region of the optical device is narrow enough to generate coupling therebetween.

9. The optical device of claim 8, wherein the partial region is a first region,
an interval between the first and second waveguides in a second region of the optical device adjacent to the first region is too large to generate coupling therebetween,
an interval between the first and second waveguides in a third region of the optical device adjacent to the second region is narrow enough to generate coupling therebetween, and
the second electrode is selectively connected to a second cladding layer of the second waveguide positioned in the second region.

10. The optical device of claim 1, wherein the second waveguide is a resonant ring having a closed ring shape.

11. The optical device of claim 10, further comprising a dropping waveguide disposed at an opposite side to the first waveguide based on the resonant ring,
wherein the first waveguide is a transmission waveguide.

12. The optical device of claim 11, further comprising a second resonant ring positioned between the resonant ring and the dropping waveguide,
wherein the resonant ring is a first resonant ring.

13. The optical device of claim 12, wherein the first and second resonant rings have the same layer configuration.

14. The optical device of claim 13, wherein the transmission waveguide, the first and second resonant rings, and the dropping waveguide have the same layer configuration.

15. An optical device comprising:
a first waveguide extended in one direction; and
a second waveguide positioned at a side of the first waveguide and including a first cladding layer, a second cladding layer, and a core layer positioned between the first and second cladding layers, the core layer having an effective refractive index changed depending on a bias voltage applied to the first and second cladding layers.

16. The optical device of claim 15, wherein one end of the first waveguide and one end of the second waveguide are coupled to each other and the other end of the first waveguide and the other end of the second waveguide are coupled to each other, and
an interval between the first and second waveguides in regions in which one ends of the first and second waveguides are coupled to each other and the other ends of the first and second waveguides are coupled to each other is too large to generate coupling therebetween.

17. The optical device of claim 15, wherein an interval between the first and second waveguides in a first region of the optical device is narrow enough to generate coupling therebetween,
an interval between the first and second waveguides in a second region of the optical device adjacent to the first region is too large to generate coupling therebetween,
an interval between the first and second waveguides in a third region of the optical device adjacent to the second region is narrow enough to generate coupling therebetween, and
in the second waveguide, an effective refractive index of the core layer is not changed in the first and third regions and is selectively changed in the second region depending on a bias voltage applied to the first and second cladding layers.

18. The optical device of claim 15, wherein the second waveguide is a resonant ring having a closed ring shape.

19. The optical device of claim 18, further comprising a dropping waveguide extended on the substrate at an opposite side to the first waveguide based on the resonant ring,
wherein the first waveguide is a transmission waveguide.

20. The optical device of claim 19, further comprising a second resonant ring positioned between the resonant ring and the dropping waveguide and a first cladding layer, a second cladding layer, and a core layer positioned between the first and second cladding layers, the core layer having an effective refractive index changed depending on a bias voltage applied to the first and second cladding layers, and
wherein the resonant ring is a first resonant ring.
